(19) United States
(12) Patent Application Publication
(10) Pub. No.: US 2018/0330324 A1
(43) Pub. Date: Nov. 15, 2018

(54) TECHNOLOGY FOR DYNAMICALLY FACILITATING SHIPPING AGREEMENTS

(71) Applicant: PROJECT44, Chicago, IL (US)

(72) Inventors: Jett McCandless, Chicago, IL (US); Walid Ibrahim, Chicago, IL (US)

(21) Appl. No.: 15/595,516

(22) Filed: May 15, 2017

(51) Int. Cl. G06Q 10/08; G06Q 30/04; G06Q 10/04; G06Q 10/06; G06Q 30/02; G06F 17/30

(52) U.S. Cl. CPC G06Q 10/08345; G06Q 30/04; G06Q 10/04; G06F 17/3061; G06Q 10/06315; G06Q 30/0206; G06Q 10/06316

(57) ABSTRACT

Systems and methods for dynamically facilitating shipping agreements are disclosed. According to certain aspects, a dynamic pricing module may receive a request for a shipping quote for a shipping job from a shipper entity. The dynamic pricing module may calculate a dynamic pricing rate for a carrier entity to fulfill the shipping job based on base pricing information, a dynamic pricing rule, and certain operating conditions. The dynamic pricing module may provide the dynamic pricing rate to the shipper entity for review and potential acceptance.

### FIELD

The present disclosure is directed to technology for dynamically generating and facilitating shipping agreements or other pricing arrangements associated with the transportation of physical goods.

### BACKGROUND

The transportation and logistics industry is made up of various entities that contract or agree to handle the transportation of physical items between and among locations. In particular, the transportation and logistics industry generally includes shippers (i.e., entities having physical items to transport) and carriers (i.e., entities having transport equipment to transport the physical items). There are additional entities known as third-party logistics (3PL) entities that receive quote requests from shippers, determine rates offered by the carriers to accommodate the requests, and ultimately broker shipping agreements between a shipper and a carrier. Communication among the shippers, 3PL entities, and carriers may be facilitated using Transportation Management Systems (TMS).

Currently, a carrier must input or provide static base prices or rates associated with specified shipping jobs to its shipper and 3PL customers. Those shipper and 3PL customers then load the pricing into the system they use to manage freight, typically a TMS. For example, a carrier specifies the price for a shipment of a certain weight and dimensions from Seattle to Portland. To broker a shipping agreement between a shipper and a carrier, a 3PL entity identifies a corresponding base price (e.g., in some cases, a base price minus a pre-agreed discount) provided by the carrier, adds additional fees to the carrier price, and then provides the new price to the shipper. However, there is no effective platform for carriers to modify their pricing and communicate it to shipper and 3PL customers in real-time. Instead, the carrier must manually submit updated pricing for the 3PL entity to access and the shippers to consider. This manual updating is cumbersome and does not enable the carrier to account for real-time conditions that may impact costs associated with shipping and/or the ability of the carrier to carry out or complete a shipping agreement.

Accordingly, there is an opportunity for platforms and technologies to consider real-time operation data and dynamically manage shipping agreements accordingly.

### SUMMARY

According to embodiments, a computer-implemented method of dynamically adjusting pricing associated with shipments is provided. The method may include receiving, from a shipper entity via a network connection, a request for a shipping quote related to a shipping job involving the transportation of physical goods, the request for the shipping quote indicating a set of parameters for the shipping job, accessing base pricing data of at least one carrier entity, and determining, by a computer processor based on the base pricing data and the set of parameters for the shipping job, a base pricing rate for the at least one carrier entity to fulfill the shipping job. The method may further include determining, based on at least one current condition, a dynamic pricing rule relevant to the shipping job, the dynamic pricing rule indicating a pricing adjustment to the base pricing rate, calculating, based on the base pricing rate and the pricing adjustment indicated by the dynamic pricing rule, a dynamic pricing rate for the at least one carrier entity to fulfill the shipping job, and sending the dynamic pricing rate to the shipper entity via the network connection.

According to another embodiment, a server configured to dynamically adjust pricing associated with shipments is provided. The server may include a transceiver configured to communicate data via at least one network connection, a memory configured to store base pricing data associated with a set of carrier entities, and a dynamic pricing module executed by a processor in communication with the transceiver and the memory. The dynamic pricing module may be configured to receive, from a shipper entity via transceiver, a request for a shipping quote related to a shipping job involving the transportation of physical goods, the request for the shipping quote indicating a set of parameters for the shipping job, access, from the memory, base pricing data of at least one carrier entity of the set of carrier entities, and determine, based on the base pricing data and the set of parameters for the shipping job, a base pricing rate for the at least one carrier entity to fulfill the shipping job. The dynamic pricing module may be further configured to determine, based on at least one current condition, a dynamic pricing rule relevant to the shipping job, the dynamic pricing rule indicating a pricing adjustment to the base pricing rate, calculate, based on the base pricing rate and the pricing adjustment indicated by the dynamic pricing rule, a dynamic pricing rate for the at least one carrier entity to fulfill the shipping job, and send the dynamic pricing rate to the shipper entity via the transceiver.

### BRIEF DESCRIPTION OF THE FIGURES

FIG. 1 depicts an overview of an example system of components configured to manage and facilitate shipping agreements, in accordance with some embodiments.

FIG. 2 depicts an example signal diagram associated with managing and facilitating shipping agreements, in accordance with some embodiments.

FIGS. 3A and 3B depict example user interfaces associated with results of data analyses, in accordance with some embodiments.

FIG. 4 is a flow diagram associated with managing shipping agreements, in accordance with some embodiments.

FIG. 5 is a block diagram of an example server, in accordance with some embodiments.

### DETAILED DESCRIPTION

The present embodiments may relate to, inter alia, dynamically managing shipping agreements between shipper entities and carrier entities. According to certain aspects, a dynamic pricing module may interface, directly or indirectly, with a set of shipper entities and a set of carrier entities. One of the shipper entities may provide a request for a shipping quote related to a shipping job, and the dynamic pricing module may be configured to calculate a price for which one of the carrier entities may fulfill or complete the shipping job, and a shipping agreement may be reached. According to embodiments, the dynamic pricing module may dynamically calculate the price based on at least one current condition that is locally accessible or that may be retrieved from the carrier entity.

In operation, the set of carrier entities may provide base pricing data and a set of dynamic pricing rules to the dynamic pricing module. A shipper entity may provide a request for a shipping quote to the dynamic pricing module, where the shipping quote may specify a set of parameters, and the dynamic pricing module may determine, using the base pricing data, a base pricing rate for one or more of the carrier entities according to the set of parameters. Additionally, the dynamic pricing module may determine a relevant dynamic pricing rule based on at least one current condition, and calculate a dynamic pricing rate based on the relevant dynamic pricing rule and the base pricing rate.

The systems and methods therefore offer numerous benefits. In particular, the systems and methods enable carrier entities to effectively and efficiently provide dynamic pricing rules that accurately reflect operational conditions at the time when a shipping price may be calculated. The use of the rules to calculate shipping quotes enables the carrier entities to achieve improved realization and increased revenues. Data and information from multiple shipping agreements may be compiled and accessed by the carrier entities, which the carrier entities may use to modify the dynamic pricing rules, thus resulting in additional improved realization, increased revenues, and improved capacity utilization. In some implementations, the dynamic pricing module may analyze the compiled information and automatically modify the dynamic pricing rules. It should be appreciated that other benefits are envisioned.

The systems and methods discussed herein address a business challenge, namely a business challenge related to improving how carrier entities accurately price their services based on operational and market conditions. In conventional platforms, carrier entities periodically provide static pricing data that is used to calculate base pricing rates, however these base pricing rates do not account for any current or real-time operating conditions. In contrast, the systems and methods enable carrier entities to effectively and efficiently provide dynamic pricing rules which may be used to calculate a dynamic pricing rate that accurately reflects one or more current operating conditions. Additionally, a dynamic pricing module may leverage a set of application programming interfaces (API) to communicate with the set of carrier entities.

Therefore, the systems and methods do not merely recite the performance of some business practice known from the pre-Internet world (facilitating a shipping agreement) along with the requirement to perform it on the Internet. Instead, the systems and methods incorporate computer networks that enable communications among shipper entities, the dynamic pricing module, and carrier entities, among other entities and components. Thus, the systems and methods are necessarily rooted in computer technology in order to overcome a problem specifically arising in computer networks.

According to implementations, the systems and methods may support a dynamic, real-time or near-real-time collection, analysis, and communication of any data that may be associated with the rule assessments and pricing calculations. In particular, the systems and methods may dynamically and automatically access or retrieve operational conditions and examine dynamic pricing rules in real-time or near-real-time, may automatically and dynamically calculate dynamic pricing rates, may automatically and dynamically provide the dynamic pricing rates to shipper entities, and may automatically and dynamically modify dynamic pricing rules. In these ways, the systems and methods discussed herein address technical challenges, namely establishing dynamic data collection, analysis, and communication across dedicated computer systems, including different systems for different carrier entities and shipper entities.

Generally, carrier entities provide base pricing rates to shipper entities and to 3PL entities, where the 3PL entities typically mark up or increase the base pricing rates and sell to shipper entities at the increase amount. Conventionally, a carrier entity charges a price (“Price #1” and referred to herein as “base pricing rate”) that the carrier entity receives from a shipper or 3PL entity to transport freight, and incurs a cost (“Cost #1”) to transport the freight. Similarly, a 3PL entity pays a cost (“Cost #2”, which is the same as Price #1 or the base pricing rate) to a carrier entity to have freight transported, and charges a price (“Price #2”) to a shipper entity to have the freight transported. Further, a shipper entity pays a cost (“Cost #3”, which may be same as Price #1 (i.e., the base pricing rate) or Price #2) to a carrier entity or to a 3PL entity for the freight transport.

According to the systems and methods, a carrier entity may calculate a “dynamic pricing rate” using Cost #1 and/or Price #1 (i.e., the base pricing rate) along with at least one “dynamic pricing rule” and at least one “current condition.” Effectively, the dynamic pricing rate is the base pricing rate that is adjusted (i.e., increased or decreased) based on the dynamic pricing rule and/or the current condition. Accordingly, a 3PL entity pays a cost (i.e., the dynamic pricing rate) to the carrier entity to have freight transported, and charges a price (“Price #3”) to a shipper entity to have the freight transported. Additionally, a shipper entity pays a cost (which could be either the dynamic pricing rate or Price #3) to a carrier entity or to a 3PL entity for the freight transport.

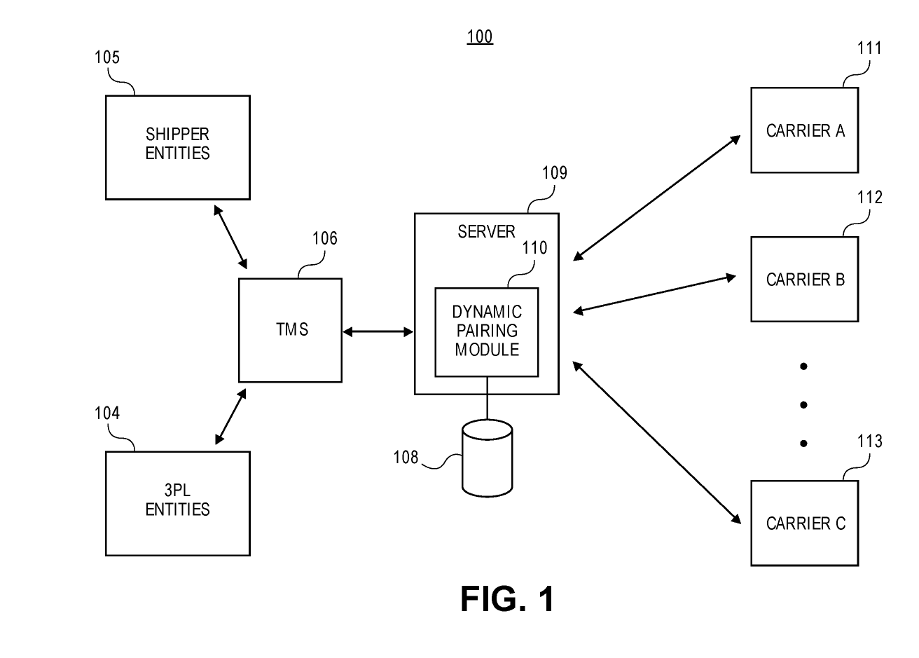

FIG. 1 illustrates an overview of a system 100 of components configured to facilitate the systems and methods. It should be appreciated that the system 100 is merely exemplary and that alternative or additional components are envisioned.

As illustrated in FIG. 1, the system 100 includes a set of shipper entities 105 and a set of 3PL entities 104. Each of the set of shipper entities 105 may be a company, corporation, business, entity, individual, group of individuals, and/or the like that may manufacture, supply, or otherwise have access to physical goods, supplies, materials, animals, and/or other items (generally, “physical goods”) capable of being physically transported. Generally, each of the set of shipper entities 105 may intend to have transported a set of physical goods from an origin location to a destination location, where the set of physical goods may have an associated weight, dimensions, and/or other parameters. It should be appreciated that various amounts of the shipper entities 105 are envisioned.

Each of the 3PL entities 104 may be a third-party provider that the set of shipper entities 105 may use to outsource certain elements associated with handling and managing the transportation of the physical goods. In some embodiments, one or more of the shipper entities 105 may include one or more of the 3PL entities 104 (or vice-versa). The set of 3PL entities 104 may manage the fulfillment of shipping requests that originate from the set of shipper entities 105. Generally, each of the set of 3PL entities 104 may manage operation, warehousing, and transportation services which may be scaled and customized to customers' needs based on certain market conditions, such as the demands and delivery requirements for products and materials, and may manage one or more particular functions within supply management, such as warehousing, transportation, or raw material provision. Each of the set of 3PL entities may be a single service or may be a system-wide bundle of services capable of managing various aspects of a supply chain (e.g., transportation of physical goods). It should be appreciated that various amounts of the 3PL entities 104 are envisioned.

The system 100 may further include a set of carrier entities (as shown: carrier A 111, carrier B 112, and carrier C 113). Each of the carrier entities 111, 112, 113 may be a company, corporation, business, entity, individual, group of individuals, and/or the like that owns or otherwise has access to a set of vehicles capable of transporting physical goods. According to embodiments, the transportation of goods may be accomplished via marine or water (i.e., using boats or ships), air (i.e., using aircraft), rail (i.e., using trains), or road (i.e., using trucks, cars, or other land-based vehicles). The shipments of the goods may be categorized differently. Generally, freight shipments may be specific to trucks and may be categorized as less than truckload (LTL) or truckload (TL). Typically, but not always, LTL shipments may range from fifty (50) to 7,000 kg in weight and 2.5 to 8.5 m in dimension, where trailers used in LTL shipments may range from 8.5 to 16.5 m, and where the shipments may be palletized, shrink-wrapped, and packaged. TL shipments are typically, but not always, larger than 7,000 kg, and may consist of physical goods that may be shipped using a single loaded truck.

The set of shipper entities 105 and the set of 3PL entities 104 may interface and communicate with a transportation management system (TMS) 106. According to embodiments, the TMS 106 may be any of a general transportation management system, warehouse management system (WMS), order management system (OMS), enterprise resource planning (ERP) system, or otherwise a system that may be used to manage freight. Generally, the TMS 106 may at least partly facilitate shipping agreements between the set of shipper entities 105 and the set of carrier entities 111, 112, 113, where the TMS 106 may facilitate route planning and optimization, load optimization, execution, freight audit and payment, yard management, advanced shipping, order visibility, and carrier management. The TMS 106 may be an open-source system or may be proprietary to any of the set of shipper entities 105 or the set of 3PL entities 104. According to embodiments, the TMS 106 may support specific and particular communication capabilities with the other entities of the system 100. In particular, the TMS 106 may support communication with the other entities via different components and protocols.

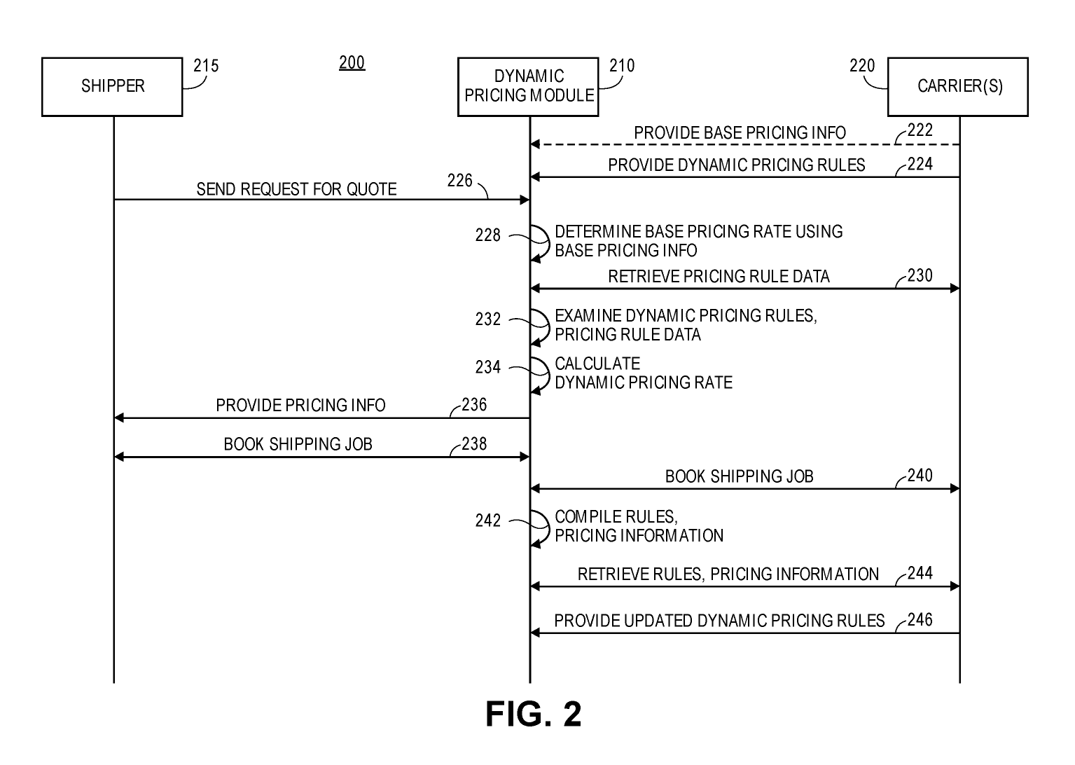

As illustrated in FIG. 1, the system 100 may include a server 109 that may interface and communicate with at least the TMS 106 and the set of carrier entities 111, 112, 113. The server 109 may include any combination or hardware and software components, and may be associated with any type of entity or individual. The server 109 may support execution of a dynamic pricing module 110. According to embodiments, the dynamic pricing module 110 may enable the calculation of a dynamic pricing rate for shipping jobs, as discussed herein with respect to FIG. 2. The dynamic pricing module 110 may interface with a database 108 or other type of memory configured to store data accessible by the dynamic pricing module 110.

Although FIG. 1 depicts the server 109 in communication with the TMS 106 and the set of carrier entities 111, 1112, 113, it should be appreciated that alternative configurations are envisioned. In one particular implementation, the TMS 106, the 3PL entity 104, and the server 109 may be combined as a single entity (i.e., the server 109 may communicate directly with the shipper entities 105 and the set of carrier entities 111, 112, 113). In another implementation, either the TMS 106 or the 3PL entity 104 may be combined with the server 109 as a single entity capable of performing the respective functionalities.

Although not depicted in FIG. 1, the system 100 may support one or more computer networks that may enable communication between and among the entities and components of the system 100. In embodiments, the computer network(s) may support any type of wired or wireless data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others). For example, the set of shipper entities 105 may communicate with the TMS 106 (and/or with the dynamic pricing module 110) via an Internet connection.

In an implementation, the set of carrier entities 111, 112, 113 may communicate with the dynamic pricing module 110 via a respective set of APIs. In particular, the dynamic pricing module 110 may retrieve information from the set of carriers 111, 112, 113 via respective API calls, where the dynamic pricing module 110 may use the retrieved information to calculate dynamic pricing data and generally facilitate functionalities associated with the systems and methods. According to embodiments, the dynamic pricing module 110 may retrieve, from the set of carrier entities 111, 112, 113 via respective API calls, a set of baseline pricing data that may represent static pricing data independent from any current operating conditions. Additionally, the dynamic pricing module 110 may retrieve, from the set of carrier entities 111, 112, 113 via respective API calls, a set of dynamic pricing rules that the dynamic pricing module 110 may use to calculate dynamic pricing data. According to embodiments, the dynamic pricing module 110 may support APIs that are particularly programmed to interface with the respective carrier entities 111, 112, 113. In particular, the dynamic pricing module 110 may support an API “A” that interfaces with carrier A 111, an API “B” that interfaces with carrier B 112, and an API “C” that interfaces with carrier C 113. It should be appreciated that the dynamic pricing module 110 may communicate with the set of carrier entities 111, 112, 113 using other connections and according to other protocols.

It should be appreciated that the components and entities of the system 100 may include and support various combinations of hardware and software components capable of facilitating various of the functionalities of the systems and methods. For example, the components and entities of the system 100 may generally support one or more computer processors, communication modules (e.g., transceivers), memories, and/or other components.

According to the general operation of the systems and methods, the dynamic pricing module 110 may access or receive quote requests originated by the shipper entity 105, where the quote requests may be associated with shipping jobs involving the transportation of physical goods. The dynamic pricing module 110 may interface with the set of carrier entities 111, 112, 113 to retrieve baseline pricing data according to parameters of the shipping jobs. Additionally, the dynamic pricing module 110 may interface with the set of carrier entities 111, 112, 113 to retrieve dynamic pricing rules that the dynamic pricing module 110 may use, along with the baseline pricing data and various current operating condition(s), to calculate a dynamic pricing rate for fulfillment of a given shipping job. The dynamic pricing module 110 may provide the dynamic pricing rate(s) to the shipper entity 105 for evaluation and selection, after which a shipping agreement may be reached. For example, carrier A 111 may offer a lower rate than carrier B 112 for a given shipping job, and the shipper entity 105 may accordingly select carrier B 112 for the shipping job. These functionalities are described in further detail with respect to FIG. 2.

FIG. 2 depicts a signal diagram 200 associated with certain functionalities related to managing and facilitating transportation shipping agreements. The signal diagram 200 includes various components including: a shipper 215 (such as one of the shipper entities 105 as discussed with respect to FIG. 1), a dynamic pricing module 210 (such as the dynamic pricing module 110 as discussed with respect to FIG. 1), and at least one carrier 220 (such as one of the carrier entities 111, 112, 113 as discussed with respect to FIG. 1).

It should be appreciated that the dynamic pricing module 210 may be any combination of hardware and software components that may be capable of facilitating the communications and functionalities as described herein, where the dynamic pricing module 210 may be included as part of a server (such as the server 109 as described with respect to FIG. 1). Further, although not depicted in FIG. 2, it should be appreciated that one or more of a TMS or at least one 3PL may communicate with one or more of the shipper 215, the dynamic pricing module 210, and the carrier(s) 220. In a particular implementation, instead of the shipper 215 communicating directly with the dynamic pricing module 210, a 3PL may communicate with the dynamic pricing module 210 on behalf of the shipper 215, and provide relevant information to the shipper 215. In the implementation depicted in FIG. 2, it should be appreciated that the dynamic pricing module 210 may be configured to perform various functionalities that may be associated with a 3PL and/or a TMS.

The signal diagram 200 may begin when the carrier(s) 220 provide (222) base pricing information to the dynamic pricing module 210. According to embodiments, each of the carriers 220 may provide respective base pricing information indicative of base rates corresponding to various shipping jobs or agreements. In some embodiments, the base rates may alternatively or additionally reflect a base cost that the respective carrier 220 is set to incur. The base rates may have associated parameters and variables, including origin location, destination location, weight of shipment, dimensions of shipment, quantity information, and/or other information. The base rates may be “static” in nature, and may therefore represent baseline amounts that the respective carrier 220 may charge for various shipping jobs. For example, one of the carriers 220 may specify a base rate of $500 to ship 2,000 kg of clothing measuring two (2) m by three (3) m from Houston to New Orleans The dynamic pricing module 210 may locally store or otherwise be configured to access the base pricing information. In an implementation, the dynamic pricing module 210 may retrieve the base pricing information from the carrier(s) 220 via a set of API calls.

The carrier(s) may also provide (224) dynamic pricing rules to the dynamic pricing module 210. According to embodiments, the dynamic pricing rules may specify or indicate a variety of factors or conditions and combinations of factors and conditions. In particular, the factors or conditions may be related to general conditions or conditions associated with operation of the carrier(s) 220. For example, the factors or conditions may include timing considerations (e.g., day of week, time of day, day of month, current month, whether the current date is a business day, etc.), shipment characteristics (e.g., freight class, packaging, stackability, etc.), customer characteristics (e.g., order size, number of orders placed, etc.), weather information, capacity information, event information (e.g., major sporting event, major conference, harvest season, etc.), origin location information (e.g., zip code, distance from nearest terminal, etc.), surge shipping information, destination location information (e.g., zip code, distance from nearest terminal, etc.), traffic information, accessorials (e.g., lift gate required, residential pickup, hazmat, inside delivery, etc.) and/or other factors. The dynamic pricing rules may also specify pricing modifications or adjustments that may be associated with the factors or conditions. In particular, the pricing modifications or adjustments may correspond to price increases or decreases relative to the base rates included in the base pricing information received in (222). The dynamic pricing module 210 may locally store or otherwise be configured to access the dynamic pricing rules. In an implementation, the dynamic pricing module 210 may retrieve the dynamic pricing rules from the carrier(s) 220 via a set of API calls.

As an example, a dynamic pricing rule may specify the following: if the requested shipping date falls on the first business day of the month, apply a 20% increase to the base rate; and if the requested shipping date falls on the second business day of the month, apply a 15% increase to the base rate. As another example, a dynamic pricing rule may specify the following: when the requested shipping date is in July, and the origin location is Chicago, apply a 20% decrease to the base rate. As an additional example, a dynamic pricing rule may specify the following: if the capacity data indicates that the available capacity of the carrier is under 5%, apply a 20% increase to the base rate. Further, for example, a dynamic pricing rule may specify the following: when real-time data indicates an unexpected interruption on a planned or current route of travel, apply a 10% increase to the base rate. It should be appreciated that additional and alternative dynamic pricing rules involving other factors and combinations of factors are appreciated.

At a certain point, the shipper 215 may send (226) a request for a shipping quote to the dynamic pricing module 210. According to embodiments, the request for the shipping quote may specify various parameters that are specific to a particular shipping job involving the transportation of physical goods. In particular, the request may specify an origin location, a destination location, a weight of shipment, classification of shipment, dimensions of shipment, quantity information, and/or other information.

After receiving the request for the shipping quote, the dynamic pricing module 210 may determine (228) a base pricing rate for the shipping quote using the base pricing information. In particular, the dynamic pricing module 210 may examine the base pricing information and identify which portion of the base pricing information corresponds to the parameters specified in the request for the shipping quote, where the dynamic pricing module 210 may determine the base pricing rate based on the identified portion of the base pricing information. For example, if the request for the shipping quote specifies a shipping job for 5,000 kg and measuring five (5) m by six (6) m, from Chicago to Los Angeles, the dynamic pricing module 210 may determine the base pricing rate from the base rate according to these parameters included in the base pricing information. It should be appreciated that the dynamic pricing module 210 may determine the base pricing rate for each of the carrier(s) 220 based on the respective base pricing information for the respective carrier(s) 220.

The dynamic pricing module 210 may also retrieve (230) pricing rule data from the carrier(s) 220. According to embodiments, the pricing rule data may include real-time or near-real-time data that may be representative of operating conditions associated with the respective carrier(s) 220. The pricing rule data may include, but not be limited to, the following: location data (i.e., information associated with the origin and/or destination locations of a shipment), shipment characteristics (i.e., information associated with a shipment such as quantities, dimensions, package classifications, linear measurements, and volumetric measurements), capacity data (i.e., data indicating available capacity that the carrier 220 has available for a given geographic area), environmental data (i.e., data describing the current or predicted environment that may affect a shipment), user integrated data (i.e., various data that may originate from systems controlled by the carrier 220, either in real-time or updated over time), activity data (i.e., data describing activity of various shippers, including current activity and historic demand curves), and user metrics (i.e., metrics that may be measured throughout interactions between and among the shipper 215, the dynamic pricing module 210, and the carrier(s) 220). It should be appreciated that the dynamic pricing module 210 may retrieve the pricing rule data via a set of API calls, or via other protocols or connections.

In implementations, the dynamic pricing module 210 may also access or determine information associated with other conditions that may be separate from the pricing rule data. In particular, the dynamic pricing module 210 may access or determine weather information, traffic conditions, origin location information, destination location information, and/or other information. It should be appreciated that the dynamic pricing module 210 may interface with one or more third party entities (not depicted in FIG. 2) to access the information.

The dynamic pricing module 210 may examine (232) the dynamic pricing rules in combination with the pricing rule data and/or other determined information to identify any applicable dynamic pricing rules to apply to the quote. In particular, the dynamic pricing module 210 may identify whether any of the dynamic pricing rules are applicable based on any current conditions, the parameters or conditions specified in the request for the quote, and/or the pricing rule data. For example, if the request specifies a shipping job from Tampa to Orlando, and the pricing rule data indicates that shipping capacity from Tampa is at 50% capacity, the dynamic pricing module 210 may identify a dynamic pricing rule specifying that when shipping capacity is at or below 60%, a 10% discount should be applied. For further example, if the request specifies a shipping job from New York City to Philadelphia, and there is severe weather in the New York City area, the dynamic pricing module 210 may identify a dynamic pricing rule specifying that when there is severe weather at an origin location, a 15% premium should be applied.

The dynamic pricing module 210 may calculate (234) a dynamic pricing rate (or in some cases, a pricing adjustment) according to the identified dynamic pricing rule. In embodiments, the dynamic pricing rate may reflect an adjustment to the base pricing rate determined in (228). For example, if the base pricing rate for a given shipping job is $500, and the dynamic pricing rule specifies a discount of 10% (i.e., $50), then the dynamic pricing rate is $450. Accordingly, the dynamic pricing rate may be a more accurate reflection of a desired rate that the respective carrier 220 may wish to charge for the shipping job.

The dynamic pricing module 210 may provide (236) the pricing information to the shipper 215, where the pricing information may reflect at least the dynamic pricing rate, and may include a dynamic pricing rate for each of the carrier(s) 220. The shipper 215 (or a user associated therewith) may examine the pricing information to assess the available options and ultimately select or decide on a preferred option. The shipper 215 may accordingly request to book (238) or finalize the shipping job according to the pricing information provided in (236). The dynamic pricing module 210 may accordingly book (240) or finalize the shipping job with the selected carrier 220. Accordingly, after the shipping job is booked or finalized, a shipping agreement may be deemed to have been reached, and the selected carrier 220 may carry out or fulfill the shipping job according to the requested parameters and for the specified pricing information.

Because the dynamic pricing module 210 may interface with multiple shippers 215 and with multiple carriers 220, as well as facilitate multiple shipping jobs, the dynamic pricing module 210 may have access to sets of data and information associated with the multiple shipping jobs. Accordingly, the dynamic pricing module 210 may accumulate, aggregate, and compile (242) various data related to shipping agreements, including which dynamic pricing rules are triggered or used, information associated with completed shipping agreements, the pricing information associated with the shipping agreements, and/or other data.

After the data is compiled, the carrier(s) 220 may retrieve (244) the compiled data, including rules, pricing information, and other information, for review and to use to implement adjustments, changes, and the like. In particular, the carrier(s) 220 may review the compiled data to identify which of the dynamic pricing rules are triggered or used, the use rate of the dynamic pricing rules, the pricing data for the shipping agreements, and/or other information. For example, a carrier may determine that a dynamic pricing rule relating to an end-of-month discount is frequently triggered.

The dynamic pricing module 210 may enable the carrier(s) 220 to access the compiled data according to various techniques and platforms. In an implementation, the dynamic pricing module 210 may support an application that users may access, where the application may support a dashboard or similar interface that may indicate the complied data and certain metrics thereof, and enable the users to make selections, modify displays, or generally facilitate other functionalities.

The carriers 220 may also provide (246) updated dynamic pricing rules to the dynamic pricing module 210, where the dynamic pricing module 210 may use the updated dynamic pricing rules for subsequent shipping quote processing. As a continuation of the above example, after the carrier determines that the dynamic pricing rule relating to the end-of-month discount is frequently triggered, the carrier may reduce the discount by a certain amount, and may provide the updated discount amount to the dynamic pricing module 210. In this regard, the carrier(s) 220 may access real-time data that indicates which of the dynamic pricing rules are effective, which of the dynamic pricing rules may need adjustments, and/or other relevant information. The carrier(s) 220 may in turn adjust, append, add to, or otherwise modify any of the dynamic pricing rules as the carrier(s) 220 sees fit.

In an implementation, the dynamic pricing module 210 may dynamically and automatically adjust or modify the dynamic pricing rules. In particular, the dynamic pricing module 210 may examine any portion of the compiled data to determine which of the dynamic pricing rules are triggered and the rate that the dynamic pricing rules are triggered, as well as the pricing data for the shipping agreements that result from the triggering of the dynamic pricing rules. The dynamic pricing module 210 may dynamically and automatically adjust or modify the dynamic pricing rules based on the examination of the compiled data. For example, if the dynamic pricing module 210 determines that a dynamic pricing rule that increases a base pricing cost by 20% when the corresponding carrier is above 95% capacity is not frequently triggered, then the dynamic pricing module 210 may lower the base cost premium from 20% to 15%.

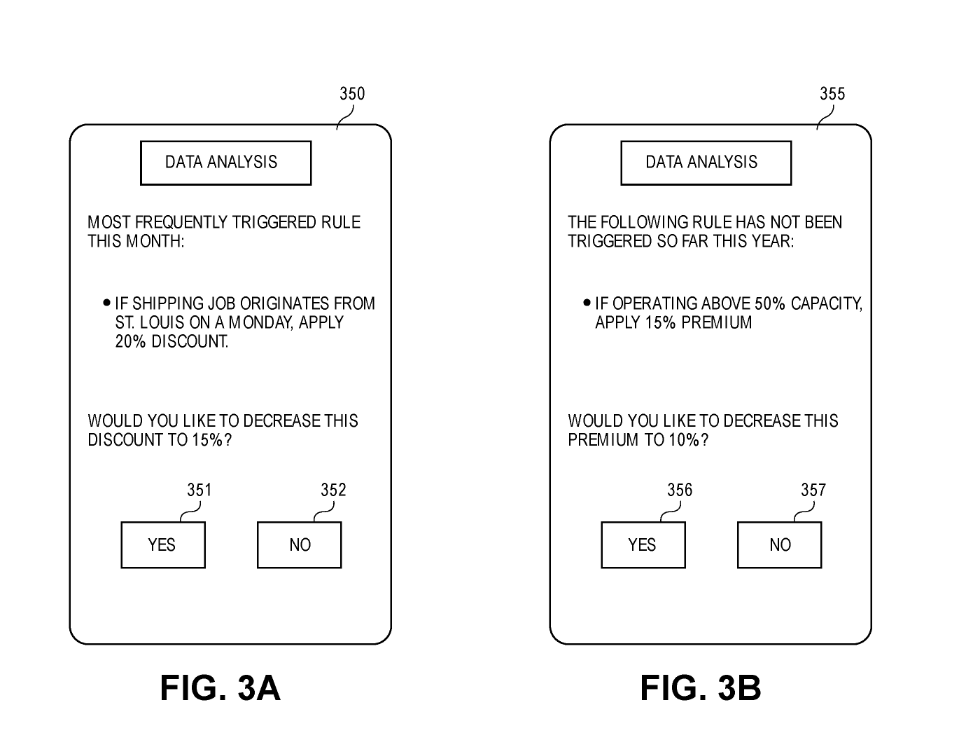

FIGS. 3A and 3B illustrate example interfaces associated with analyzing dynamic pricing rules and enabling modification of the rules. One or more electronic devices (e.g., a mobile device, such as a smartphone) may be configured to display the interfaces and/or receive selections and inputs via the interfaces. For example, a dedicated application that is configured to operate on the electronic device may display the interfaces. It should be appreciated that the interfaces and the content thereof are merely exemplary and that alternative or additional content is envisioned.

FIG. 3A depicts an interface 350 that indicates an example analysis of a set of dynamic pricing rules for a given carrier. For example, the analysis may be performed on the set of dynamic pricing rules and the use thereof over a certain time period (e.g., year-to-date). The example data analysis of the interface 350 indicates that the following dynamic pricing rule was the most frequently triggered: if shipping job originates from St. Louis on a Monday, apply 20% discount. Accordingly, the given carrier may deduce that because this dynamic pricing rule is triggered so frequently, that the discount may be too much.

The dedicated application (or other processing logic) may automatically determine that the given carrier may wish to decrease the discount in an effort to increase revenue and/or increase the trigger rate of other dynamic pricing rules. Accordingly, the interface 350 may enable a user of the electronic device to select, via a “yes” selection 351 or a “no” selection 352, to decrease the discount to 15%.

FIG. 3B depicts an interface 355 that indicates an example analysis of a set of dynamic pricing rules for a given carrier. For example, the analysis may be performed on the set of dynamic pricing rules and the use thereof over a certain time period (e.g., year-to-date). The example data analysis of the interface 355 indicates that the following dynamic pricing rule was not triggered: if operating above 80% capacity, apply 15% premium. Accordingly, the given carrier may deduce that because this dynamic pricing rule was not triggered, that the premium may be too high.

The dedicated application (or other processing logic) may automatically determine that the given carrier may wish to decrease the premium in an effort to increase the trigger rate of the dynamic pricing rule. Accordingly, the interface 355 may enable a user of the electronic device to select, via a “yes” selection 356 or a “no” selection 357, to decrease the premium to 10%.

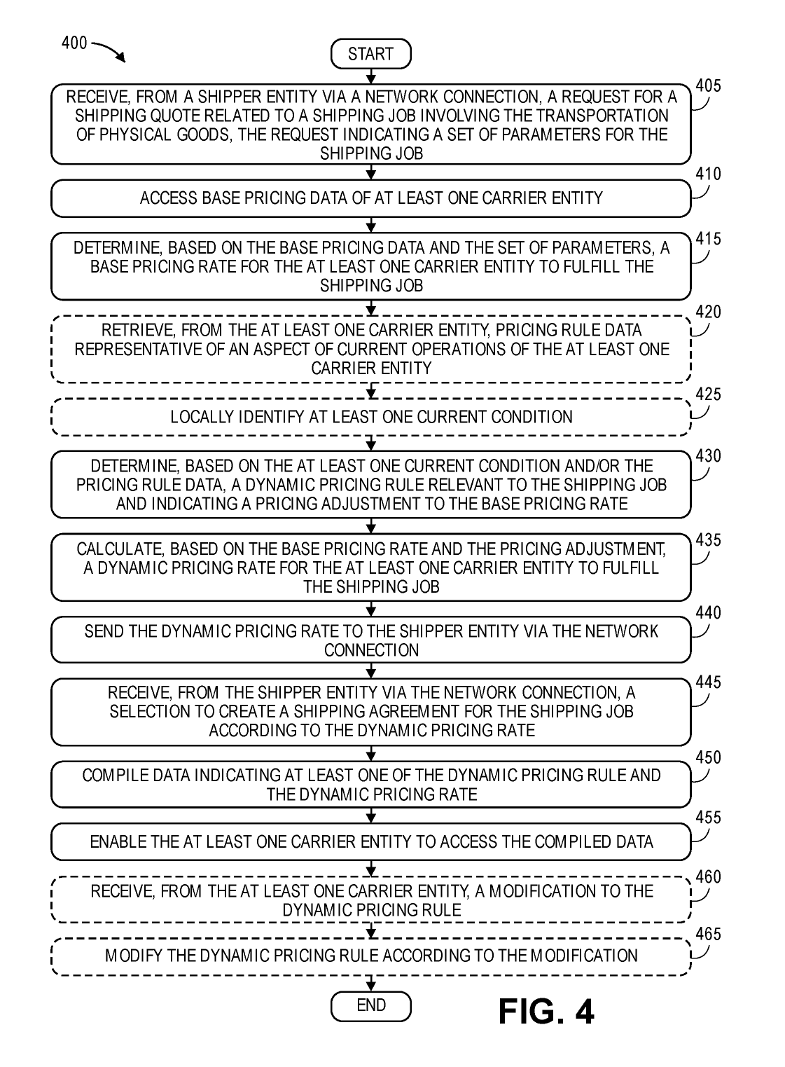

FIG. 4 depicts a block diagram of an example method 400 of dynamically managing shipping agreements. The method 400 may be facilitated by a module, electronic device, or the like (such as the dynamic pricing module 210) that may communicate with one or more entities (such as shippers and carriers) via one or more wireless network connections. In particular, the electronic device may receive, request, or retrieve data from the entities that the electronic device may use to facilitate the method 400.

The method 400 may begin with the electronic device receiving (block 405), from a shipper entity via a network connection, a request for a shipping quote related to a shipping job involving the transportation of physical goods, where the request indicates a set of parameters for the shipping job. In embodiments, the set of parameters may include one or more of the following: origin location, destination location, weight of shipment, dimensions of shipment, quantity information, and/or other information.

The electronic device may access (block 410) base pricing data of at least one carrier entity. In embodiments, the electronic device may locally access the base pricing data, or may access the base pricing data from the at least one carrier entity (e.g., via an API call), where each carrier entity may have its own base pricing data. The electronic device may determine (block 415), based on the base pricing data and the set of parameters, a base pricing rate for the at least one carrier entity to fulfill the shipping job. According to embodiments, the determined base pricing rate may reflect the set of parameters included in the request for the shipping quote.

The electronic device may optionally retrieve (block 420), from the at least one carrier entity, pricing rule data that is representative of an aspect of current operation of the at least one carrier entity. The pricing rule data may include location data, shipment characteristics, capacity data, environmental data, user integrated data, activity data, user metrics, and/or the like. The electronic device may also optionally locally identify (block 425) at least one current condition, such as timing considerations, weather information, origin location information, destination location information, traffic information, and/or the like.

The electronic device may determine (block 430), based on the at least one current condition and/or the pricing rule data, a dynamic pricing rule relevant to the shipping job and indicating a pricing adjustment to the base pricing rate. In embodiments, the dynamic pricing rule may reflect the set of parameters included in the request for the shipping quote, and may indicate a premium or discount to the base pricing rate. Accordingly, the electronic device may calculate (block 435), based on the base pricing rate and pricing adjustment, a dynamic pricing rate for the at least one carrier entity to fulfill the shipping job.

The electronic device may send (block 440) the dynamic pricing rate to the shipper entity via the network connection, where the shipper entity may review the dynamic pricing rate and choose to either reject or accept the dynamic pricing rate for the shipping job. If the shipper entity accepts the dynamic pricing rate, the electronic device may receive (block 445), from the shipper entity via the network connection, a selection to create a shipping agreement for the shipping job according to the dynamic pricing rate. The electronic device may also notify the carrier entity of the shipping agreement. Accordingly, at this point, the shipper entity and the carrier entity have the shipping agreement to complete the shipping job according to set of parameters and the dynamic pricing rate.

The electronic device may further compile (block 450) data indicating at least one of the dynamic pricing rule and the dynamic pricing rate. In embodiments, the electronic device may compile the data along with additional data associated with additional shipping agreements. The electronic device may enable (block 455) the at least one carrier entity to access the compiled data, such as via a user interface that displays metrics, statistics, and the like as part of a dashboard or similar interface.

The electronic device may optionally receive (block 460), from the at least one carrier entity, a modification to the dynamic pricing rule. In particular, the at least one carrier entity may wish to modify the dynamic pricing rule based on a usage or triggering frequency of the dynamic pricing rule. The electronic device may optionally modify (block 465) the dynamic pricing rule according to the modification. In an implementation, the electronic device may automatically analyze the compiled data, determine how to modify the dynamic pricing rule based on the analysis, and automatically modify the dynamic pricing rule accordingly (or, in some cases, automatically generate one or more new dynamic pricing rules).

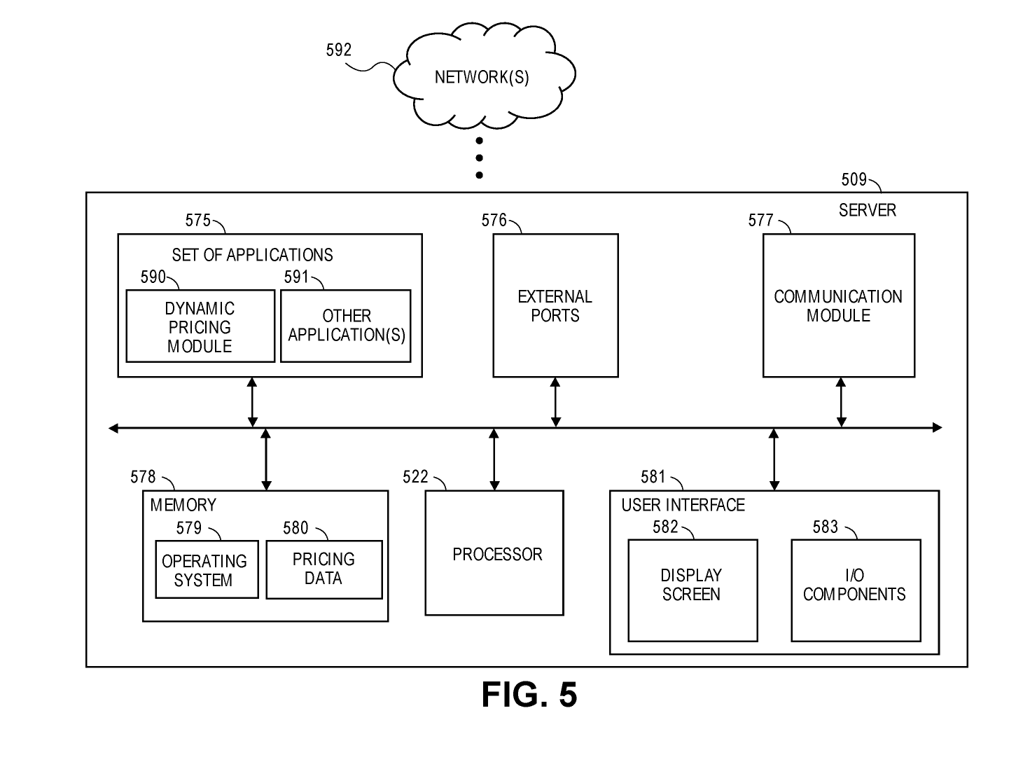

FIG. 5 illustrates a diagram of an example server 509 (such as the server 109 as discussed with respect to FIG. 1) in which the functionalities as discussed herein may be implemented. It should be appreciated that the server 509 may be configured to be connect to and communicate with various entities, components, and devices, as discussed herein. In one implementation, the components of the server 509 may be included in an electronic device.

The server 509 may include a processor 522 as well as a memory 578. The memory 578 may store an operating system 579 capable of facilitating the functionalities as discussed herein as well as a set of applications 575 (i.e., machine readable instructions). For example, one of the set of applications 575 may be a dynamic pricing module 590 configured to manage and facilitate certain of the functionalities as discussed herein. It should be appreciated that one or more other applications 591 are envisioned, such as an application that enables carrier entities to access shipping data and information and make pricing modifications.

The processor 522 may interface with the memory 578 to execute the operating system 579 and the set of applications 575. According to some embodiments, the memory 578 may also store pricing data 580 that the dynamic pricing module 590 may access for certain functionalities. The memory 578 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The server 509 may further include a communication module 577 configured to communicate data via one or more networks 592. According to some embodiments, the communication module 577 may include one or more transceivers (e.g., WWAN, WLAN, and/or WPAN transceivers) functioning in accordance with IEEE standards, 3GPP standards, or other standards, and configured to receive and transmit data via one or more external ports 576.

The server 509 may further include a user interface 581 configured to present information to a user and/or receive inputs from the user. As shown in FIG. 5, the user interface 581 may include a display screen 582 and I/O components 583 (e.g., ports, capacitive or resistive touch sensitive input panels, keys, buttons, lights, LEDs). According to some embodiments, the user may access the server 509 via the user interface 581 to review information and/or perform other functions.

In some embodiments, the server 509 may perform the functionalities as discussed herein as part of a “cloud” network or may otherwise communicate with other hardware or software components within the cloud to send, retrieve, or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 522 (e.g., working in connection with the operating system 579) to facilitate the functions as described herein. In this regard, the program code may be implemented in any desired language, and may be implemented as machine code, assembly code, byte code, interpretable source code or the like (e.g., via C, C++, Java, Actionscript, Objective-C, Javascript, CSS, XML). In some embodiments, the computer program product may be part of a cloud network of resources.

Although the following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

What is claimed is:

1. A computer-implemented method of dynamically adjusting pricing associated with shipments, the method comprising:
receiving, from a shipper entity via a network connection, a request for a shipping quote related to a shipping job involving the transportation of physical goods, the request for the shipping quote indicating a set of parameters for the shipping job;
accessing base pricing data of at least one carrier entity;
determining, by a computer processor based on the base pricing data and the set of parameters for the shipping job, a base pricing rate for the at least one carrier entity to fulfill the shipping job;
determining a dynamic pricing rule relevant to the shipping job, the dynamic pricing rule indicating a pricing adjustment to the base pricing rate;
calculating, based on the base pricing rate and the pricing adjustment indicated by the dynamic pricing rule, a dynamic pricing rate for the at least one carrier entity to fulfill the shipping job; and
sending the dynamic pricing rate to the shipper entity.

2. The computer-implemented method of claim 1, wherein determining the dynamic pricing rule relevant to the shipping job comprises:
determining, based on at least one current condition, the dynamic pricing rule relevant to the shipping job.

3. The computer-implemented method of claim 1, wherein determining the dynamic pricing rule relevant to the shipping job comprises:
retrieving, from the at least one carrier entity, pricing rule data representative of an aspect of current operations of the at least one carrier entity; and
determining, based on the pricing rule data, the dynamic pricing rule relevant to the shipping job.

4. The computer-implemented method of claim 3, wherein retrieving the pricing rule data comprises:
retrieving the pricing rule data from the at least one carrier entity via an application programming interface (API).

5. The computer-implemented method of claim 1, wherein determining the dynamic pricing rule relevant to the shipping job comprises:
locally identifying at least one current condition; and
determining, based on the at least one current condition, the dynamic pricing rule relevant to the shipping job.

6. The computer-implemented method of claim 1, wherein determining the dynamic pricing rule relevant to the shipping job comprises:
retrieving, from the at least one carrier entity, pricing rule data representative of an aspect of current operations of the at least one carrier entity;
locally identifying at least one current condition; and
determining, based on the pricing rule data and the at least one current condition, the dynamic pricing rule relevant to the shipping job.

7. The computer-implemented method of claim 1, further comprising:
compiling data indicating at least one of the dynamic pricing rule and the dynamic pricing rate; and
enabling the at least one carrier entity to access the compiled data.

8. The computer-implemented method of claim 7, wherein enabling the at least one carrier entity to access the compiled data comprises:
generating a dashboard interface that indicates at least a portion of the compiled data; and
enabling the at least one carrier entity to access the dashboard interface.

9. The computer-implemented method of claim 7, further comprising:
receiving, from the at least one carrier entity, a modification to the dynamic pricing rule; and
modifying the dynamic pricing rule according to the modification.

10. The computer-implemented method of claim 1, further comprising:
compiling data indicating at least one of the dynamic pricing rule and the dynamic pricing rate;
analyzing the compiled data; and
automatically at least one of (i) adjusting the dynamic pricing rule based on the analysis of the compiled data and (ii) generating a new dynamic pricing rule.

11. The computer-implemented method of claim 1, further comprising:
receiving, from the shipper entity via the network connection, a selection to create a shipping agreement for the shipping job according to the dynamic pricing rate.

12. A server configured to dynamically adjust pricing associated with shipments, comprising:
a transceiver configured to communicate data via at least one network connection;
a memory configured to store base pricing data associated with a set of carrier entities;
a dynamic pricing module executed by a processor in communication with the transceiver and the memory, the dynamic pricing module configured to:
receive, from a shipper entity via transceiver, a request for a shipping quote related to a shipping job involving the transportation of physical goods, the request for the shipping quote indicating a set of parameters for the shipping job,
access, from the memory, base pricing data of at least one carrier entity of the set of carrier entities,
determine, based on the base pricing data and the set of parameters for the shipping job, a base pricing rate for the at least one carrier entity to fulfill the shipping job,
determine a dynamic pricing rule relevant to the shipping job, the dynamic pricing rule indicating a pricing adjustment to the base pricing rate,
calculate, based on the base pricing rate and the pricing adjustment indicated by the dynamic pricing rule, a dynamic pricing rate for the at least one carrier entity to fulfill the shipping job, and
send the dynamic pricing rate to the shipper entity.

13. The server of claim 12, wherein to determine the dynamic pricing rule relevant to the shipping job, the dynamic pricing module is configured to:
determine, based on at least one current condition, the dynamic pricing rule relevant to the shipping job.

14. The server of claim 12, wherein to determine the dynamic pricing rule relevant to the shipping job, the dynamic pricing module is configured to:
retrieve, from the at least one carrier entity, pricing rule data representative of an aspect of current operations of the at least one carrier entity, and
determine, based on the pricing rule data, the dynamic pricing rule relevant to the shipping job.

15. The server of claim 14, wherein to retrieve the pricing rule data, the dynamic pricing module is configured to:
retrieve the pricing rule data from the at least one carrier entity via an application programming interface (API).

16. The server of claim 12, wherein to determine the dynamic pricing rule relevant to the shipping job, the dynamic pricing module is configured to:
locally identify at least one current condition, and
determine, based on the at least one current condition, the dynamic pricing rule relevant to the shipping job.

17. The server of claim 12, wherein to determine the dynamic pricing rule relevant to the shipping job comprises:
retrieve, from the at least one carrier entity, pricing rule data representative of an aspect of current operations of the at least one carrier entity,
locally identify at least one current condition, and
determine, based on the pricing rule data and the at least one current condition, the dynamic pricing rule relevant to the shipping job.

18. The server of claim 12, wherein the dynamic pricing module is further configured to:
compile data indicating at least one of the dynamic pricing rule and the dynamic pricing rate; and
enable the at least one carrier entity to access the compiled data.

19. The server of claim 18, wherein to enable the at least one carrier entity to access the compiled data, the dynamic pricing module is configured to:
generate a dashboard interface that indicates at least a portion of the compiled data, and
enable the at least one carrier entity to access the dashboard interface.

20. The server of claim 18, wherein the dynamic pricing module is further configured to:
receive, from the at least one carrier entity, a modification to the dynamic pricing rule, and
modify the dynamic pricing rule according to the modification.

21. The server of claim 12, wherein the dynamic pricing module is further configured to:
compile data indicating at least one of the dynamic pricing rule and the dynamic pricing rate,
analyzing the compiled data, and
automatically at least one of (i) adjust the dynamic pricing rule based on the analysis of the compiled data and (ii) generate a new dynamic pricing rule.

22. The server of claim 12, wherein the dynamic pricing module is further configured to:
receive, from the shipper entity via the transceiver, a selection to create a shipping agreement for the shipping job according to the dynamic pricing rate.
